(19) United States
(12) Patent Application Publication
(10) Pub. No.: US 2025/0101192 A1
(43) Pub. Date: Mar. 27, 2025

(54) MOISTURE-PERMEABLE WATERPROOF FILM

(71) Applicant: FAR EASTERN NEW CENTURY CORPORATION, TAIPEI (TW)

(72) Inventors: HSIAO CHAN WANG, TAIPEI (TW); CHENG TING WANG, TAIPEI (TW)

(21) Appl. No.: 18/656,611

(22) Filed: May 7, 2024

(30) Foreign Application Priority Data
Sep. 27, 2023 (TW) 112137196

(51) Int. Cl. C08J 5/18; C08G 18/42; C08G 18/48; C08G 18/76

(52) U.S. Cl. CPC C08J 5/18; C08G 18/4202; C08G 18/4244; C08G 18/48; C08G 18/7671; C08J 2375/04

(57) ABSTRACT

The present disclosure provides a moisture permeable waterproof film. The moisture permeable waterproof film includes polyurethane including a hard segment, a first soft segment, and a second soft segment. The first soft segment includes an aromatic polyether-ester group. A modulus of the moisture permeable waterproof film is more than about 50 kgf/cm², and a moisture permeability of the moisture permeable waterproof film is more than about 30000 g/m²*24 hr. When an amount of the first soft segment is about 1 mole, an amount of the hard segment is equal to or more than about 4.5 moles.

### BACKGROUND OF THE PRESENT DISCLOSURE

### Field of the Present Disclosure

The present disclosure relates to a moisture-permeable waterproof film.

### Description of the Prior Art

Polyurethane is a common polymer material in life. It is widely used in foam products (such as sponges), elastic damping materials (such as shoe soles), coatings (such as stainless steel tank coatings), adhesive, and moisture-permeable waterproof film, etc. Polyurethane can be widely used in various fields because its properties can be adjusted through different ingredient combinations. Generally, polyurethane compositions mainly include isocyanate, polyol, chain extender, etc., and the composition components of polyurethane composition can be adjusted according to the properties required in different application fields of polyurethane.

The polyurethane composition may contain a variety of polyols, generally polyester polyols or polyether polyols, and recycled polyols can also be used. For example, U.S. Pat. No. 4,469,823 discloses that aromatic polyester polyol is obtained by reacting recycled poly(ethylene terephthalate (PET) with C2-C4 dibasic acid and alkylene glycol, and then the aromatic polyester polyol mentioned above is reacted with polyisocyanate to synthesize polyurethane foaming materials. For another example, U.S. Pat. No. 9,458,354 discloses that aromatic polyester polyol is obtained by reacting recycled PET with C2-C4 dibasic acid and neopentyl glycol, and then the aromatic polyester polyol mentioned above is reacted with polyisocyanate to synthesize polyurethane materials. In addition, the types of chain extenders in the polyurethane composition may also affect its properties. For example, U.S. Pat. No. 4,540,768 discloses the use of chain extenders with amine groups to prepare polyurethane materials. Since the amine-based structure has a high modulus, it can be used in injection molding materials.

The above technologies utilize aromatic polyester polyols derived from recycled polyester as one of the polyurethane formulations. Its advantage is to make the product more environmentally friendly and reduce carbon emissions. If these formulations can be applied to other fields, such as moisture-permeable waterproof films, they should be more eco-friendly. However, the formulations of the above technologies cannot be directly used in moisture-permeable waterproof films. For example, the polyurethane with aliphatic dibasic acid group structure, as disclosed in U.S. Pat. No. 4,469,823, exhibits relatively high hardness, which will make the hand feel more rigid when used in moisture-permeable waterproof films, consequently reducing comfort during wear. Further, for example, the polyurethane with neopentyl glycol polyurethane structure, as disclosed in U.S. Pat. No. 9,458,354, has high hydrophobicity, which reduces moisture permeability when being used in moisture-permeable waterproof films. In addition, TWI766384 discloses the use of derivatives from recycled PET bottles as a formulation for making polyurethane. However, there are various types of structures of the derivatives from recycled PET bottles, and not all of these derivatives can produce moisture-permeable waterproof films with soft touch feel, high moisture permeability and high modulus (higher modulus usually comes with higher water pressure resistance). The structure of the polyurethane synthesized according to the prior art TWI766384 is different from that of this application. The polyurethane of prior arts mainly uses a derivative of recycled PET bottles to synthesize polyurethane, the derivative having a structure represented by

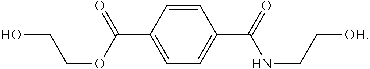 [SMILES: O=C(NCCO)c1ccc(C(=O)OCCO)cc1]

Although it can improve the strength of polyurethane, it cannot achieve sufficient moisture permeability.

From the above description, it can be seen that in order to achieve a moisture-permeable waterproof film that is environmentally friendly and carbon-reducing, has a soft hand feel, and has both moisture permeability and high modulus, further research and development of polyurethane chemical structures suitable for making moisture-permeable waterproof films are required. This disclosure is to develop a polyurethane composition that has good wearing comfort and achieves the physical property requirements of a moisture-permeable waterproof film (water pressure resistance and high moisture permeability).

### SUMMARY OF THE PRESENT DISCLOSURE

In some embodiments, the present disclosure provides a moisture permeable waterproof film, which includes a polyurethane, wherein the polyurethane includes a hard segment, a first soft segment and a second soft segment, the first soft segment includes an aromatic polyether-ester group, a modulus of the moisture permeable waterproof film is more than about 50 kgf/cm², and a moisture permeability of the moisture permeable waterproof film is more than about 30000 g/m²*24 hr. When an amount of the first soft segment is about 1 mole, an amount of the hard segment is equal to or more than about 4.5 moles. The first soft segment includes a structure of formula (I) below:

—X1-Y1- Formula (I);
wherein X1 includes at least one aromatic isocyanate group, and Y1 includes the aromatic polyether-ester group, wherein Y1 includes a structure of formula (IA) or formula (IB) below:

—[(CO)—R—(CO)—O—R′—O]ₙ— Formula (IA);

—[(CO)—R—(CO)—O—R′—O—(CO)—O—R′—O]ₙ— Formula (IB);
wherein R is an aromatic group, R′ is a polyether group, the R groups in the first soft segments can be the same or different from one another, the R′ groups in Formula (IB) can be the same or different from one another, the CO groups connected to R are in ortho, meta or para position to each other, and n is an integer equal to or greater than 1;
wherein the second soft segment includes a structure of formula (II) below:

—X2-Y2- Formula (II);
wherein X2 includes at least one aromatic isocyanate group, Y2 includes an aliphatic polyether group, a number average molecular weight of the aliphatic polyether group is equal to or greater than about 3000 g/mol, and Y2 includes a structure of formula (IIA) below:

—[O—R¹]ₘ₁—O— Formula (IIA);
wherein R¹ is a C2-C4 aliphatic hydrocarbon, m1 is an integer equal to or greater than 1, and when m1 is an integer equal to or greater than 2, R¹ may be the same or different each time it appears.

### DETAILED DESCRIPTION OF THE EMBODIMENTS

The following disclosure provides many different embodiments or examples. Each aspect and each embodiment disclosed in this disclosure can be combined individually with other aspects and embodiments disclosed in this disclosure and combined into all possible combinations thereof.

In the specification and claims, unless the context clearly dictates otherwise, the singular forms “a” and “the” include the plural. Unless otherwise claimed, any and all examples provided or illustrative language used (e.g., “such as”) in this disclosure are merely intended to better illustrate the present disclosure and do not limit the scope of the present disclosure.

Here, the terms “about”, “around” and “approximately” generally mean within 20%, preferably within 10%, more preferably within 5%, or within 3%, or within 2%, or within 1%, or within 0.5%, of a given value or range. It should be noted that the quantities provided in the specification are approximate quantities, that is, “about”, “around” or “approximately” may still be implied without being specifically stated.

Embodiments of the present disclosure provide a polyurethane, a moisture-permeable waterproof film, and a manufacturing method of polyurethane. The first soft segment of the polyurethane contains both an aromatic structure and a polyether structure simultaneously. The aromatic structure can improve the strength of polyurethane, and the polyether structure can improve the hydrophilicity of polyurethane, which can compensate the hydrophobic properties of the aromatic structure. As a result, the polyurethane can have both good strength and hydrophilicity, which is beneficial for producing moisture-permeable waterproof films that exhibit not only good modulus but also effective moisture permeability. Furthermore, when the molar ratio of the hard segment relative to the first soft segment of the polyurethane meets the conditions of the present disclosure (for example, equal to or greater than 4.5), higher structural strength can be provided for the polyurethane, thereby making the polyurethane products (e.g., the moisture-permeable waterproof film) have a relatively high modulus (e.g., a modulus of at least about 50 kgf/cm²).

In some embodiments, the present disclosure provides a polyurethane. The polyurethane includes at least one hard segment and at least one soft segment. The soft segment of the polyurethane may include at least one aromatic polyether-ester group. The aromatic polyether-ester group may also be referred as “aromatic polyether-ester group”. The soft segment of the polyurethane may also be referred as “aromatic polyether-ester segment”. According to some embodiments of the present disclosure, the soft segment includes a first soft segment in the polyurethane. The first soft segment has both an aromatic structure and a polyether structure. The aromatic structure can improve the strength of the polyurethane, and the polyether structure can improve the hydrophilicity of the polyurethane, so that the polyurethane can have good strength and moisture permeability and hydrophilicity. According to some embodiments of the present disclosure, synthesis of polyurethane involves not only the careful control of the ratio of the soft segment to the hard segment but also requires the meticulous selection of aromatic structures and polyether structures within the soft segment. Accurate control is crucial for successfully synthesizing waterproof and breathable films, especially when using recycled polyethylene terephthalate (rPET)-derived recycled polyols. Therefore, with the designs of the present disclosure, recycled polyols can be used to prepare moisture-permeable waterproof films with desired properties.

In some embodiments, when an amount of the first soft segment is about 1 mole, an amount of the hard segment is equal to or more than about 4.5 moles. In other words, the molar ratio of the hard segment relative to the first soft segment (or aromatic polyether-ester segment) of the polyurethane may be equal to or greater than about 4.5. In some embodiments, the molar ratio of the hard segment relative to the first soft segment of the polyurethane can be equal to or greater than about 4.8, 5, 5.3, 6, 7, 7.5, 8, 8.5 or 8.8. In some embodiments, the molar ratio of the hard segment relative to the first soft segment of the polyurethane may be equal to or less than about 10. In some embodiments, the molar ratio of the hard segment relative to the first soft segment of the polyurethane may be equal to or less than about 9.8, 9.5, 9.3 or 8.9.

In some embodiments, the first soft segment may include a structure of formula (I) below:

—X1-Y1- Formula (I);
wherein X1 may include at least one aromatic isocyanate group. In some embodiments, X1 may include an aromatic diisocyanate group. For example, X1 may have the following structure: —[(CO)N—Rx-N(CO)]—, wherein Rx may be an aromatic group.

In some embodiments, Y1 may include a structure of formula (IA) or formula (IB) below:

—[(CO)—R—(CO)—O—R′—O]ₙ— Formula (IA);

—[(CO)—R—(CO)—O—R′—O—(CO)—O—R′—O]ₙ— Formula (IB);
wherein R may be an aromatic group, R′ may be a polyether group, the R groups in the first soft segments can be the same or different from one another, the R′ groups in Formula (IB) can be the same or different from one another, the CO groups connected to R are in ortho, meta or para position to each other, and n may be an integer equal to or greater than 1.

In some embodiments, Y1 may include a structure of formula (IA) above and a structure of formula (IA-1) below. In some embodiments, Y1 may include a structure of formula (IB) above and a structure of formula (IB-1) below.

—[(CO)—R—(CO)—O—R″—O]ₙ— Formula (IA-1);

—[(CO)—R—(CO)—O—R″—O—(CO)—O—R″—O]ₙ— Formula (IB-1),
wherein R″ may be a C2-C4 aliphatic hydrocarbon. In some embodiments, a number-average molecular weight (Mn) of the aromatic polyether-ester group in the first soft segment is equal to or greater than about 450 g/mol. In some embodiments, the number-average molecular weight of the aromatic polyether-ester group is equal to or greater than about 900 g/mol, 1200 g/mol, 1600 g/mol or 1900 g/mol. In some embodiments, the number-average molecular weight of the aromatic polyether-ester group is equal to or less than about 2000 g/mol.

In some embodiments, the aromatic polyether-ester group may include poly(ethylene terephthalate) (PET)-repeating units, poly(trimethylene terephthalate) (PTT)-repeating units, poly(butylene terephthalate) (PBT) repeating units or repeating units of the like. In some embodiments, the aromatic polyether-ester group may include poly(ethylene terephthalate)-polyether repeating units, poly(trimethylene terephthalate)-polyether repeating units, poly(butylene terephthalate)-polyether repeating units, or aromatic polyether-ester repeating units of the like. In some embodiments, the aromatic polyether-ester group may include poly(ethylene terephthalate)-polyether-polyester repeating units, poly(trimethylene terephthalate)-polyether-polyester repeating units, poly(butylene terephthalate)-polyether-polyester repeating units, or aromatic polyether-ester-polyester repeating units of the like.

In some embodiments, the aromatic polyether-ester group may be or include a depolymerized product derived from polyester. In some embodiments, the depolymerized product is obtained through depolymerization of polyester and polyether polyol. The polyester may be or be derived from, for example, poly(ethylene terephthalate) (PET), poly(trimethylene terephthalate) (PTT), poly(butylene terephthalate) (PBT) or the like.

In some embodiments, the aromatic polyether-ester group may be or include a depolymerized product derived from a reaction of polyester with polyether polyol. In some embodiments, the aromatic polyether-ester group may be or include a depolymerized product produced from a depolymerization reaction of a derivative of, for example, poly(ethylene terephthalate) (PET), poly(trimethylene terephthalate) (PTT), poly(butylene terephthalate) (PBT) or the like with polyether polyol. In some embodiments, the number average molecular weight of the aforementioned polyether polyol is equal to or greater than 130 g/mol. In some embodiments, the aforementioned polyether polyol include aliphatic polyol. In some embodiments, the aforementioned polyether polyol includes diethylene glycol (DEG), triethylene glycol (TEG) or a combination thereof. In some embodiments, the depolymerized product may include a structure of formula (A), formula (B) and/or formula (C) below:

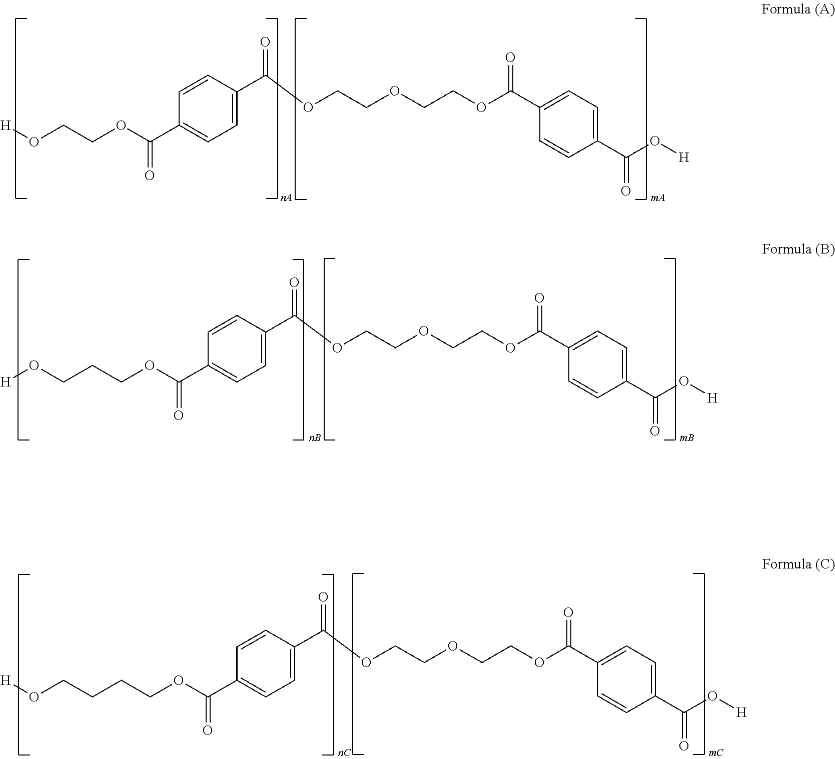

wherein nA, nB, nC, mA, mB and mC are each an integer equal to or greater than 1.

In some embodiments, the aromatic polyether-ester group may be or include a depolymerized product derived from polyester and polyether polyol, a polymer obtained by reacting the above depolymerized product with carbonate, or a combination thereof. In some embodiments, the aromatic polyether-ester group may be or include a depolymerized product produced from a depolymerization reaction of, for example, poly(ethylene terephthalate) (PET), poly(trimethylene terephthalate) (PTT), poly(butylene terephthalate) (PBT) or the like with polyether polyol. In some embodiments, the aromatic polyether-ester group may be or include a polymer obtained by further reacting the aforementioned depolymerized product with carbonate. In some embodiments, the number average molecular weight of the aforementioned polyether polyol is equal to or greater than about 130 g/mol. In some embodiments, the aforementioned carbonate includes dimethyl carbonate (DMC), ethylene carbonate (EC), propylene carbonate (PC) or diphenyl carbonate (DPC).

Polyester (for example, polyethylene terephthalate (PET)) is widely used in making daily necessities such as PET bottles and textile fibers due to its properties of high strength and long life. However, the disposal of the large amount of polyester waste generated has also become a major problem. With the international emphasis on environmental protection measures in recent years, the industry has gradually developed various technologies for recycling and reusing plastic waste (for example, polyester waste). How to efficiently recycle polyester waste and reuse it in polyester products has become one of the research and development goals in the industry. According to some embodiments of the present disclosure, the aromatic polyether-ester group is or includes a depolymerized product derived from the polyester, which can be directly used as one of the raw materials to perform the polymerization reaction for making polyurethane, thereby having the advantages of being environmentally friendly and reduced energy consumption.

Further, the depolymerized product of polyester contains aromatic polyester polyol groups. The aromatic polyester polyol groups have relatively high hydrophobicity; however, the polyurethane used to make moisture-permeable waterproof films requires high hydrophilicity, thus depolymerized products of polyester are generally not used as raw materials for the preparation of polyurethane. In contrast, according to some embodiments of the present disclosure, the aromatic polyether-ester group is or includes a depolymerized product derived from the reaction of polyester with at least one polyether polyol, the depolymerized product has both the polyether structure and the aromatic structure, so it is a flowing liquid at room temperature, which is advantageous to the feeding of polymerization materials, thereby improving the processability and convenience of the polymerization process steps. Furthermore, the polyether structure can enhance hydrophilicity and help improve the moisture permeability of polyurethane and its products (for example, the moisture-permeable waterproof films).

In some embodiments, the first soft segment does not include aliphatic dibasic acid groups and neopentyl glycol groups. In some embodiments, the first soft segment does not include the product derived from the reaction of depolymerized products of polyester with aliphatic dibasic acids (e.g., C2-C4 dibasic acids). In some embodiments, the first soft segment does not include the product derived from the reaction of polyester with neopentyl glycol.

According to some embodiments of the present disclosure, the first soft segment of the polyurethane does not include aliphatic dibasic acid group and/or the product derived from the reaction of the polyester with the aliphatic dibasic acid. Since the aliphatic dibasic acid group has a structure that may induce partial crystallization and thus results in a higher hardness, when it is used in polyurethane and its products (for example, moisture-permeable waterproof films), the hand feel would be relatively stiff, and the wearing comfort may be reduced. Therefore, the polyurethane and its products (for example, moisture-permeable waterproof film) of the present disclosure have a relatively soft hand feel, and the clothing made thereof has better wearing comfort. Furthermore, according to some embodiments of the present disclosure, the first soft segment of the polyurethane does not include neopentyl glycol group and/or the product derived from the reaction of polyester with neopentyl glycol, because neopentyl glycol has a structure with relatively high hydrophobicity and would reduce moisture permeability when being used in polyurethane and its products (for example, moisture-permeable waterproof films). Therefore, the polyurethane and its products (e.g., moisture-permeable waterproof film) of the present disclosure have relatively high hydrophilicity and thus have better moisture permeability.

In some embodiments, the polyurethane may further include another soft segment (or referred to as a “second soft segment”) that is different from the aforementioned first soft segment. In some embodiments, the second soft segment may include an aliphatic polyether group. The second soft segment of the polyurethane may also be referred to as an “aliphatic polyether segment”.

In some embodiments, the molar ratio of the first soft segment (or aromatic polyether-ester segment) relative to the second soft segment (or aliphatic polyether segment) of the polyurethane may be equal to or greater than approximately 3. In some embodiments, the molar ratio of the first soft segment relative to the second soft segment of the polyurethane may range from about 1.4 to 8.5, about 3.8 to 8, or about 4 to 7.8. In some embodiments, when the first soft segment has an amount of about 1 mole, the second soft segment has an amount of about 0.1 to 1 mol. In some embodiments, when the first soft segment has an amount of about 1 mole, the second soft segment has an amount of about 0.11 mol, about 0.3 mol, about 0.4 mol, about 0.5 mol, about 0.6 mol, about 0.7 mol or about 0.8 mol.

In some embodiments, the second soft segment may include a structure of formula (II) below:

—X2-Y2- Formula (II);
wherein X2 may include at least one aromatic isocyanate group, and Y2 may include an aliphatic polyether group. In some embodiments, X2 may include aromatic diisocyanate groups. For example, X2 may include the following structure: —[(CO)N—Rx-N(CO)]—, where Rx may be an aromatic group.

In some embodiments, Y2 may include a structure of formula (IIA) below:

—[O—R¹]ₘ₁—O— Formula (IIA);
wherein R¹ is a C2-C4 aliphatic hydrocarbon, m1 is an integer equal to or greater than 1, and when m1 is an integer equal to or greater than 2, R¹ may be the same or different each time it appears.

In some embodiments, the number average molecular weight of the aliphatic polyether groups in the second soft segment is equal to or greater than 3000 g/mol. In some embodiments, the aliphatic polyether groups have a number average molecular weight of 3000 g/mol to 9000 g/mol. In some embodiments, the aliphatic polyether groups have a number average molecular weight of equal to or greater than about 3000 g/mol, 3400 g/mol, 6000 g/mol or 9000 g/mol. In some embodiments, the aliphatic polyether groups have a number average molecular weight of equal to or less than about 10,000 g/mol.

In some embodiments, the aliphatic polyether group may include polyglycol group repeating units. In some embodiments, the aliphatic polyether group may include polyethylene glycol (PEG) group repeating units, polypropylene glycol (PPG) group repeating units, polytetramethylene ether glycol (PTMEG) group repeating units or a block copolymer of any combination thereof. In some embodiments, the aliphatic polyether group may include a PEG group, a co-PEG-PPG group, a co-PEG-PTMEG group or the like.

In some embodiments, the aliphatic polyether group may be or include a repeating unit prepared from the polyether polyol. In some embodiments, the aliphatic polyether group may be or include a group or a repeating unit prepared from polyethylene glycol (PEG), polypropylene glycol (PPG), polytetramethylene ether glycol (PTMEG) or any combination thereof.

In some embodiments, the hard segment may include a structure of formula (III) below:

—X3-Y3- Formula (III);
wherein X3 may include at least one aromatic isocyanate group. In some embodiments, X3 may include an aromatic diisocyanate group. For example, X3 may include the following structure: —[(CO)N—Rx-N(CO)]—, where Rx may be an aromatic group.

In some embodiments, Y3 may include a structure of formula (IIIA) below:

—O—R^{a}—O— Formula (IIIA);
wherein R^{a} is an aliphatic hydrocarbon. In some embodiments, R^{a} is a C2-C4 aliphatic hydrocarbon.

According to some embodiments of the present disclosure, the polyurethane further includes the first soft segment (or the aromatic polyether-ester segment). In addition to the polyether structure that can improve the hydrophilicity of polyurethane, the aromatic structure can further increase the strength of polyurethane, so it can provide a relatively high structural strength for polyurethane, such that the polyurethane products (such as moisture-permeable waterproof films) can have a modulus of at least about 50 kgf/cm².

Furthermore, according to some embodiments of the present disclosure, the polyurethane further contains the second soft segment (or aliphatic polyether segment) with a relatively high number average molecular weight. Since the aliphatic polyether segment with a relative high number average molecular weight can further improve the moisture permeability of the polyurethane products (e.g., the moisture-permeable waterproof films). In addition, according to some embodiments of the present disclosure, the molar ratio of the first soft segment (or the aromatic polyether-ester segment) to the second soft segment (or the aliphatic polyether segment) of the polyurethane meets the aforementioned conditions, which can further make the polyurethane have both good strength and hydrophilicity.

In some embodiments, “S1” indicates the mole number of the first soft segment (or the aromatic polyether-ester segment), “S2” indicates the mole number of the second soft segment, “H1” indicates the mole number of the hard segment, “M1” represents the molar ratio of the first soft segment (or the aromatic polyether-ester segment) relative to a sum of the hard segment, the first soft segment and the second soft segment (M1=(S1/(H1+S1+S2))*100), and M1 is equal to or less than about 20. In some embodiments, M1 is equal to or less than about 18, 17.5, or 17. In some embodiments, M1 is equal to or greater than about 9. In some embodiments, M1 is equal to or greater than about 9.2 or 9.5.

In some embodiments, the present disclosure provides a moisture-permeable waterproof film, which includes the aforementioned polyurethane. In some embodiments, the modulus of the moisture-permeable waterproof film is greater than about 50 kgf/cm². In some embodiments, the modulus of the moisture-permeable waterproof film is greater than about 52 kgf/cm², 53 kgf/cm² or 54 kgf/cm². In some embodiments, the modulus of the moisture-permeable waterproof film is equal to or less than about 80 kgf/cm². In some embodiments, the modulus of the moisture-permeable waterproof film is equal to or less than about 75 kgf/cm², 70 kgf/cm², 65 kgf/cm² or 60 kgf/cm². In some embodiments, the moisture permeability of the moisture-permeable waterproof film is greater than about 30,000 g/m²*24 hr. The term “modulus (also known as “100% modulus)” described in the present disclosure is the secant modulus under 100% elongation, whose test method is based on the ASTMD638 specification (Load Cell: 50N, Crosshead Speed: 200 mm/min). The term “moisture permeability” described in the present disclosure is the moisture permeability of a sample at a temperature of 30° C. and a humidity of 65% RH, which is measured in accordance with the JIS L1099 B1 standard test method, with a unit of g/m²*24 hr.

In some embodiments, the present disclosure provides a manufacturing method of polyurethane, which may include at least the following steps: providing isocyanate, linear diol, aliphatic polyol (for example, long carbon chain polyether polyol), and aromatic polyether-ester polyol, which are mixed into a mixture, and then heating the mixture to perform a polymerization reaction on the mixture, thereby obtaining the polyurethane.

In some embodiments, the isocyanate includes organic isocyanate, such as aliphatic isocyanate and/or aromatic isocyanate. In some embodiments, the isocyanate includes diisocyanate. In some embodiments, the isocyanate includes aromatic diisocyanate. In some embodiments, the isocyanate may include trimethylene diisocyanate, tetramethylene diisocyanate, pentamethylene diisocyanate, hexamethylene diisocyanate, heptamethylene diisocyanate and/or octamethylene diisocyanate, 2-methylpentamethylene-1,5-diisocyanate, 2-ethylbutylene-1,4-diisocyanate, pentamethylene-1,5-diisocyanate, butylene-1,4-diisocyanate, isophorone diisocyanate (IPDI), 1,4-bis(isocyanatomethyl)cyclohexane and/or 1,3-bis(isocyanatomethyl)cyclohexane (HXDI), 1,4-cyclohexane diisocyanate, 1-methyl-2,4-cyclohexane diisocyanate and/or 1-methyl-2,6-cyclohexane diisocyanate, 4,4′-dicyclohexylmethane diisocyanate, 2,4′-dicyclohexylmethane diisocyanate and/or 2,2′-dicyclohexylmethane diisocyanate, 2,2′-diphenylmethane diisocyanate, 2,4′-diphenylmethane diisocyanate and/or 4,4′-diphenylmethane diisocyanate (MDI), 1,5-naphthylene diisocyanate (NDI), 2,4-toluene diisocyanate and/or 2,6-toluene diisocyanate (TDI), o-tolidine diisocyanate (TODI), p-phenyl diisocyanate (PPDI), 1,2-diphenylethane diisocyanate and/or phenylene diisocyanate, 4,4′-dicyclohexylmethane diisocyanate (H12MDI), 2,4′-dicyclohexylmethane diisocyanate (H12MDI), 2,2′-dicyclohexylmethane diisocyanate (H12MDI), 2,4-p-phenylene diisocyanate (PPDI), tetramethylxylylene diisocyanate (TMXDI) or any combination thereof.

In some embodiments, the aliphatic polyol includes an aliphatic polyether polyol. In some embodiments, the number average molecular weight of the aliphatic polyether polyol is equal to or greater than about 3000 g/mol. In some embodiments, the number average molecular weight of the aliphatic polyether polyol is equal to or greater than about 3000 g/mol, 3400 g/mol, 6000 g/mol, or 9000 g/mol. In some embodiments, the aliphatic polyether group may contain a repeating unit of polydiol groups. In some embodiments, the aliphatic polyether polyol may include polyethylene glycol (PEG), polypropylene glycol (PPG), polytetramethylene ether glycol (PTMEG) or a copolymer of any combination thereof. In some embodiments, the aliphatic polyether polyol may include PEG, co-PEG-PPG, co-PEG-PTMEG or the like.

In some embodiments, the manufacturing method of the aromatic polyether-ester polyol may include at least the following steps: providing polyester, and then adding polyether polyol to the polyester to perform depolymerization of polyester, thereby obtaining the aromatic polyether-ester polyol. In some embodiments, the prepared aromatic polyether-ester polyol has a hydroxyl number of equal to or less than about 37.4 mg KOH/g. In some embodiments, the prepared aromatic polyether-ester polyol has a hydroxyl number of equal to or less than about 37 mg KOH/g, 30 mg KOH/g, 20 mg KOH/g, 13 mg KOH/g or 12.5 mg KOH/g. The term “hydroxyl number” described in the present disclosure represents the amount (mg) of KOH required for neutralization of the OH functional group per gram (g) of sample, measured by ASTM E1899-16 standard method, with a unit of “mg KOH/g.”

In some embodiments, the number average molecular weight of the polyether polyol for depolymerization of polyester is equal to or greater than about 130 g/mol. In some embodiments, the aforementioned polyether polyol includes the aliphatic polyol. In some embodiments, the aforementioned polyether polyol includes diethylene glycol ether (DEG).

Providing the aromatic polyether-ester polyol further includes: during the depolymerization step, when a hydroxyl number of an intermediate product of the depolymerization step reaches 245 to 255 mg KOH/g, adding a carbonate compound to the intermediate product to proceed with a polymerization reaction until the hydroxyl number reaches about 56 mg KOH/g, and then stopping the reaction to obtain the product.

In some other embodiments, the aromatic polyether-ester polyol may also be made by polymerization reaction. In some embodiments, the aromatic polyether-ester polyol may be made through the polymerization reaction of terephthalic acid (TPA), ethylene glycol (EG) and polyethylene glycol (PEG).

In some embodiments, the manufacturing method of polyurethane may use the chain extender, which may include the aliphatic compound and/or the aromatic compound. In some embodiments, the chain extender may include diamines and/or alkylene glycols, such as C2-C8 alkylene glycols, or only have primary hydroxyl groups. In some embodiments, the linear diol is used as the chain extender for polymerization. In some embodiments, the chain extender may include 1,2-ethylene glycol, 1,2-propylene glycol, 1,3-propylene glycol, 1,4-butylene glycol, 2,3-butylene glycol, 1,5-pentanediol, 1,6-hexanediol, diethylene glycol, dipropylene glycol, cyclohexane-1,4-diol, cyclohexane-1,4-dimethanol, neopentyl glycol, hydroquinone bis(2-hydroxyethyl) ether (HQEE) or any combination thereof. In some embodiments, the chain extender includes amine compounds, so that the prepared polyurethane has a high modulus. In some embodiments, the chain extender may not include the amine compounds since the first soft segment (or the aromatic polyether-ester segment) of the polyurethane already includes the aromatic structure, which helps to increase the modulus of polyurethane.

In some embodiments, the mixture can be heated for polymerization to obtain the polyurethane. In some embodiments, the groups of the chain extender described above and isocyanate (e.g., aromatic diisocyanate) form the hard segment of polyurethane by polymerization reactions. In some embodiments, the aforementioned aromatic polyether-ester polyol and isocyanate (e.g., aromatic diisocyanate) form the first soft segment (or aromatic polyether-ester segment) of polyurethane by polymerization reactions. In some embodiments, the aforementioned aliphatic polyol and isocyanate (for example, aromatic diisocyanate) form a second soft segment (or aliphatic polyether segment) of polyurethane by polymerization reactions. At this point, the polyurethane of the present disclosure is formed.

The present disclosure will be further illustrated based on the following examples and comparative examples, but it should be understood that the following examples are only for exemplary illustration, and should not be construed as restrictions on the implementation of the present disclosure.

### [Raw Materials]

<Isocyanate>: 4,4′-diphenylmethane diisocyanate (MDI), a product of Tosoh Millionate MT.
<Aliphatic polyol>: as shown in Table 1 below.

TABLE 1

| Product name | PEG9000 | PEG3400 | PEG2000 |
|---|---|---|---|
| Company | Oriental Union | Oriental Union | Oriental Union |
| | Chemical Corp. | Chemical Corp. | Chemical |
| | | | Corp. |
| Degree of functionality | 2 | 2 | 2 |
| Number average | 9000 | 3400 | 2000 |
| molecular | | | |
| weight (g/mol) | | | |
| Hydroxyl number | 12.5 | 33 | 56 |
| (mg KOH/g) | | | |

<Aromatic polyether-ester polyol>: As shown in Table 2 below.

TABLE 2

| Product name | rPET201 | rPET041 | PCrP201 |
|---|---|---|---|
| Company | Oriental Union | Oriental Union | Oriental Union |
| | Chemical Corp. | Chemical Corp. | Chemical Corp. |
| Degree of functionality | 2 | 2 | 2 |
| Number average | 2000 | 450 | 2000 |
| molecular | | | |
| weight (g/mol) | | | |
| Hydroxyl number | 56.1 | 250 | 56.1 |
| (mg KOH/g) | | | |

The preparation steps of “rPET041” are as what follows: PET (100 g, 0.52 mol), DEG (138 g, 1.30 mol) and zinc acetate (0.1 g, 0.1 wt % relative to PET) were placed in a 500 mL round-bottomed bottle and heated to 200° C. in a nitrogen environment to initiate the depolymerization reaction. The hydroxyl number of the reactants was tracked continuously. When the hydroxyl number reached 250±5 mg KOH/g, the reaction was terminated to obtain the aromatic polyether-ester polyol “rPET041.”

The preparation steps of “rPET201” are as what follows: PET (100 g, 0.52 mol), DEG (138 g, 1.30 mol) and zinc acetate (0.1 g, 0.1 wt % relative to PET) were placed in a 500 mL round-bottomed bottle and heated to 200° C. in a nitrogen environment to initiate the depolymerization reaction. The hydroxyl number of the reactants was tracked continuously. When the hydroxyl number reached 250±5 mg KOH/g, the pressure of the reaction environment in the round-bottomed bottle was adjusted to 2 torr to proceed with the reaction. When the hydroxyl number of the reactants reached 56.1±3 mg KOH/g, the reaction was terminated to obtain the aromatic polyether-ester polyol “rPET201.”

In some embodiments, the depolymerization process of PET to form “rPET201” and “rPET041” can be expressed by the reaction formula (IV) below:

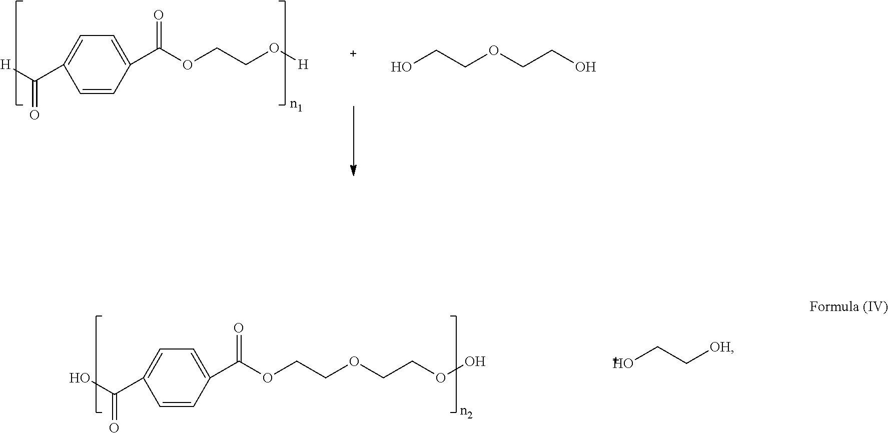

wherein n₁ and n₂ are integers equal to or greater than 1 respectively, and n₁>n₂. “rPET201” and “rPET041” have the same structure, except that their values of n₂ and number average molecular weights are different.

The preparation steps of “PCrP201” are as follows: PET (100 g, 0.52 mol), DEG (138 g, 1.30 mol) and zinc acetate (0.1 g, 0.1 wt % relative to PET) were placed in a 500 mL round-bottomed bottle and heated to 200° C. in a nitrogen environment to initiate the depolymerization reaction. The hydroxyl number of the reactants was tracked continuously. When the hydroxyl number reached 250±5 mg KOH/g, dimethyl carbonate (37.47 g, 0.42 mol) was further added into the reactants, the reaction temperature was adjusted to 150° C., and the pressure of the reaction environment in the round-bottomed bottle was adjusted to 30 torr to proceed with the reaction. When the hydroxyl number of the reactants reached 56.1±3 mg KOH/g, the reaction was terminated to obtain the aromatic polyether-ester polyol “PCrP201.”

In some embodiments, the reaction process of forming “PCrP201” from the further reaction of the depolymerized product of PET and dimethyl carbonate (DMC) can be expressed by the reaction formula (V) below:

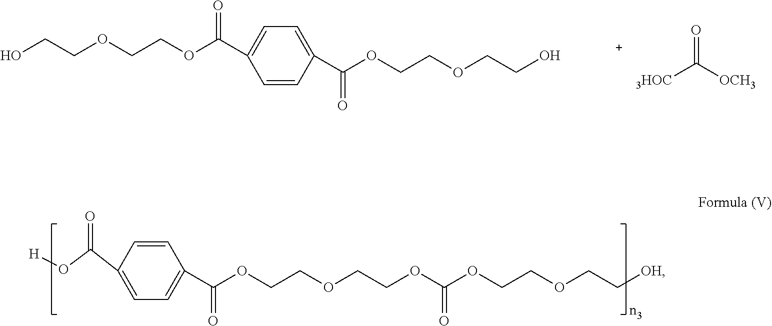

wherein n₃ is an integer equal to or greater than 1, preferably 2 to 10, and more preferably 3 to 6.
<Chain extender>: Ethylene glycol (EG), a product of Oriental Union Chemical Corp.
<Solvent>: Dimethylacetamide (DMAC), an Acros product.

### Polymerization Reaction

### Examples 1 to 7 and Comparative Examples 1 to 7

16.283 g of PEG9000, 16.397 g of aromatic polyether-ester polyol “rPET201”, 2.477 g of aromatic polyether-ester polyol “rPET041”, 4.151 g of EG, and 56 g of solvent DMAc were weighted, placed into a glass reaction tank and reacted under nitrogen with a stirring speed of 100 rpm. 20.691 g of MDI was added under continuous stirring. The reaction started when the temperature of the reaction system reached 70° C. When the viscosity of the reactants increased to the point where rod-climbing phenomenon occurred, 104 g of the solvent DMAc was added to completely dissolve the product in the solvent. The batch size of the product at this time was 200 g and the solid content was 30 wt %.

Example 1 was taken as an example to illustrate the preparation process. The polymerization steps of Examples 1 to 7 and Comparative Examples 1 to 7 are the same, except that the type and content of the reactant raw materials were different. The experimental conditions of the polymerization steps of Examples 1 to 7 and Comparative Examples 1 to 7 and the physical property results of the polyurethanes prepared therefrom are as shown in Table 3, Table 4A and Table 4B below.

Table 3 indicates the amount of raw materials used in Examples 1 to 7 and Comparative Examples 1 to 7 (i.e., the amount of each reactant added) and expressed by weight, and the unit is “gram (g).”

TABLE 3

| Raw | | | | | | | | | |
|---|---|---|---|---|---|---|---|---|---|
| material | | | | | | | | | |
| usage (g) | MDI | EG | PEG9000 | PEG3400 | PEG2000 | rPET201 | rPET041 | rPHB05 | PCrP201 |
| Ex. 1 | 20.691 | 4.151 | 16.283 | 0 | 0 | 16.397 | 2.477 | 0 | 0 |
| Ex. 2 | 20.483 | 4.143 | 17.647 | 0 | 0 | 15.401 | 2.326 | 0 | 0 |
| Ex. 3 | 20.721 | 4.231 | 17.09 | 0 | 0 | 15.938 | 2.02 | 0 | 0 |
| Ex. 4 | 20.543 | 4.396 | 16.791 | 0 | 0 | 18.27 | 0 | 0 | 0 |
| Ex. 5 | 21.653 | 4.718 | 16.888 | 0 | 0 | 16.741 | 0 | 0 | 0 |
| Ex. 6 | 19.708 | 4.28 | 17.501 | 0 | 0 | 0 | 0 | 0 | 18.512 |
| Ex. 7 | 19.969 | 4.149 | 0 | 17.503 | 0 | 0 | 0 | 0 | 18.379 |
| Comp. Ex. | 22.209 | 2.697 | 15.661 | 0 | 0 | 0 | 19.433 | 0 | 0 |
| 1 | | | | | | | | | |
| Comp. Ex. | 18.886 | 3.631 | 16.906 | 0 | 0 | 17.961 | 2.616 | 0 | 0 |
| 2 | | | | | | | | | |
| Comp. Ex. | 18.179 | 3.495 | 19.144 | 0 | 0 | 16.664 | 2.518 | 0 | 0 |
| 3 | | | | | | | | | |
| Comp. Ex. | 19.768 | 3.891 | 17.93 | 0 | 0 | 15.607 | 2.803 | 0 | 0 |
| 4 | | | | | | | | | |
| Comp. Ex. | 20.113 | 3.966 | 0 | 0 | 16.402 | 0 | 0 | 0 | 19.519 |
| 5 | | | | | | | | | |
| Comp. Ex. | 21.786 | 2.313 | 0 | 0 | 9.949 | 0 | 0 | 25.951 | 0 |
| 6 | | | | | | | | (rPHB05_600) | |
| Comp. Ex. | 20.874 | 3.144 | 10 | 0 | 6.542 | 0 | 0 | 29.440 | 0 |
| 7 | | | | | | | | (rPHB05_1000) | |

In Table 4A and Table 4B, “H1:S2:S1” represents the molar ratio of the hard segment:the second soft segment:the first soft segment in the polyurethane, “S2/S1” represents the molar ratio of the second soft segment relative to the first soft segment in the polyurethane, “H1/S1” represents the molar ratio of the hard segment relative to the first soft segment in the polyurethane, “X1”, “X2”, “X3”, “Y1”, “Y2” and “Y3” represent different groups, “M1” represents the molar ratio of the first soft segment relative to the sum of the hard segment, the first soft segment and the second soft segment (M1=(S1/(H1+S1+S2))*100), the unit of “100% modulus” is “Kgf/cm²”, and the unit of “moisture permeability” is “g/m²*24 hr”. “100% modulus” is the secant modulus at 100% elongation. The test method is based on the ASTM D638 specification (Load Cell: 50N, Crosshead Speed: 200 mm/min). “Moisture permeability” is the moisture permeability of the sample at a temperature of 30° C. and a humidity of 65% RH and measured in accordance with the JIS L1099 B1 standard test method. The “100% modulus” and “moisture permeability” in Table 4B are both measured on samples with a film thickness of 20 μm.

TABLE 4A

| Segment | H1 | | S2 | | S1 | |
|---|---|---|---|---|---|---|
| Group | X3 | Y3 | X2 | Y2 | X1 | Y1 |
| Ex. 1 | MDI | EG | MDI | PEG9000 | MDI | rPET201 |
| | | | | | | rPET041 |
| Ex. 2 | MDI | EG | MDI | PEG9000 | MDI | rPET201 |
| | | | | | | rPET041 |
| Ex. 3 | MDI | EG | MDI | PEG9000 | MDI | rPET201 |
| | | | | | | rPET041 |
| Ex. 4 | MDI | EG | MDI | PEG9000 | MDI | rPET201 |
| Ex. 5 | MDI | EG | MDI | PEG9000 | MDI | rPET201 |
| Ex. 6 | MDI | EG | MDI | PEG9000 | MDI | PCrP201 |
| Ex. 7 | MDI | EG | MDI | PEG3400 | MDI | PCrP201 |
| Comp. Ex. 1 | MDI | EG | MDI | PEG9000 | MDI | rPET041 |
| Comp. Ex. 2 | MDI | EG | MDI | PEG9000 | MDI | rPET201 |
| | | | | | | rPET041 |
| Comp. Ex.3 | MDI | EG | MDI | PEG9000 | MDI | rPET201 |
| | | | | | | rPET041 |
| Comp. Ex. 4 | MDI | EG | MDI | PEG9000 | MDI | rPET201 |
| | | | | | | rPET041 |
| Comp. Ex. 5 | MDI | EG | MDI | PEG2000 | MDI | PCrP201 |
| Comp. Ex. 6 | MDI | EG | MDI | PEG2000 | MDI | rPHB05_600 |
| Comp. Ex. 7 | MDI | EG | MDI | PEG2000 | MDI | rPHB05_1000 |

TABLE 4B

| | | | | | | | | Moisture |
|---|---|---|---|---|---|---|---|---|
| Segment | S2 | S1 | | | | | 100% | perme- |
| Group | Y2 | Y1 | H1:S2:S1 | S2/S1 | H1/S1 | M1 | modulus | ability |
| Ex. 1 | PEG9000 | rPET201 | 37:1:7.7 | 0.13 | 4.81 | 16.8 | 54 | 35915 |
| | | rPET041 | | | | | | |
| Ex. 2 | PEG9000 | rPET201 | 34.1:1:6.7 | 0.15 | 5.09 | 16.0 | 55 | 56468 |
| | | rPET041 | | | | | | |
| Ex. 3 | PEG9000 | rPET201 | 35.9:1:6.7 | 0.15 | 5.36 | 15.4 | 54 | 66328 |
| | | rPET041 | | | | | | |
| Ex. 4 | PEG9000 | rPET201 | 38:1:5 | 0.20 | 7.60 | 11.4 | 54 | 53165 |
| Ex. 5 | PEG9000 | rPET201 | 40.6:1:4.6 | 0.22 | 8.83 | 10.0 | 60 | 30037 |
| Ex. 6 | PEG9000 | PCrP201 | 35.5:1:4 | 0.25 | 8.88 | 19.9 | 54 | 70062 |
| Ex. 7 | PEG3400 | PCrP201 | 13:1:1.5 | 0.67 | 8.67 | 19.7 | 64 | 59361 |
| Comp. Ex. | PEG9000 | rPET041 | 25:1:25 | 0.04 | 1.00 | 49.0 | 45 | 6416 |
| 1 | | | | | | | | |
| Comp. Ex. | PEG9000 | rPET201 | 31.2:1:8 | 0.13 | 3.90 | 19.9 | 37 | 59460 |
| 2 | | rPET041 | | | | | | |
| Comp. | PEG9000 | rPET201 | 26.5:1:6.65 | 0.15 | 3.98 | 19.5 | 33 | 96351 |
| Ex.3 | | rPET041 | | | | | | |
| Comp. Ex. | PEG9000 | rPET201 | 31.5:1:7.5 | 0.13 | 4.20 | 18.8 | 38 | 58093 |
| 4 | | rPET041 | | | | | | |
| Comp. Ex. | PEG2000 | PCrP201 | 7.8:1:1 | 1.00 | 7.80 | 10.2 | 64 | 12154 |
| 5 | | | | | | | | |
| Comp. Ex. | PEG2000 | rPHB05_600 | 7.5:1:9 | 0.11 | 0.83 | 51.4 | 60 | 1279 |
| 6 | | | | | | | | |
| Comp. Ex. | PEG2000 | rPHB05_1000 | 15.5:1:9 | 0.11 | 1.72 | 35.3 | 37 | 6263 |
| 7 | | | | | | | | |

As can be seen from the results of Table 3, Table 4A and Table 4B above, in some embodiments, when the molar ratio of the hard segment relative to the first soft segment (or the aromatic polyether-ester segment) of the polyurethane meets the conditions described above in the present disclosure (for example, equal to or greater than 4.5), the polyurethane can have a modulus of at least about 50 kgf/cm². Furthermore, from the results of Table 3, Table 4A and Table 4B above, it can be seen that in some embodiments, when the number average molecular weight of the aliphatic polyol (Y2) is greater than 3000 g/mol, the polyurethane can have a moisture permeability of greater than about 30000 g/m²*24 hr.

In some comparative examples, the aliphatic polyol (Y1) derivative “rPHB05” series generated by recycling the PET bottle has a reaction formula (VI) as below:

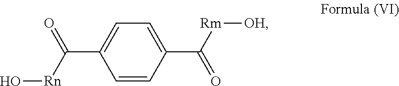

wherein Rn and Rm are derived from diol compounds, amino alcohol compounds or a combination thereof. The diol compounds include aliphatic diols, aromatic diols or polyether diols, and the amino alcohol compounds include aliphatic alcohol-amine or aromatic alcohol-amine.

The polyurethane waterproof films of Comparative Examples 6-7 are produced using derivatives of recycled PET bottles as starting materials. The derivatives “rPHB05_600” and “rPHB05_1000” have the reaction formula as shown in the following formula (VII), where n₄+m₄ is 8-22, and “rPHB05_600” and “rPHB05_1000” each have properties as shown in Table 5 below.

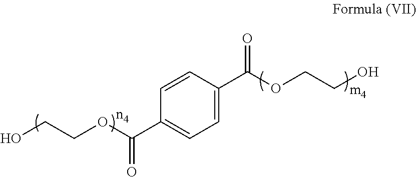

TABLE 5

| | rPHB05_600 | rPHB05_1000 |
|---|---|---|
| Number average molecular weight | 600 | 1000 |
| (g/mol) | | |
| Hydroxyl number (mg KOH/g) | 18.7 | 11.2 |
| n₄ + m₄ | 10.6 | 19.7 |

The first soft segment (the aromatic polyether-ester group) in the polyurethane waterproof film of Comparative Example 6 has a chemical structure of formula (VIII) below, and its number average molecular weight is 600 g/mol.

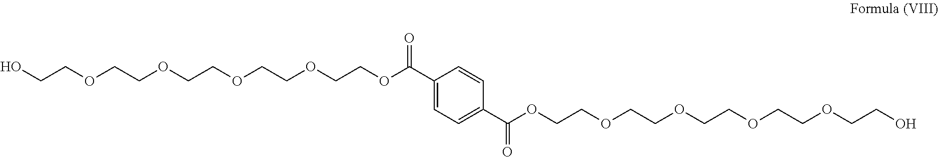 [SMILES: O=C(OCCOCCOCCOCCOCCO)c1ccc(C(=O)OCCOCCOCCOCCOCCO)cc1]

Normally, the chemical structures of the above-mentioned formulas (VII) and (VIII) are produced by using polyether glycol to degrade PET. As shown by the results of Comparative Example 6, when the above structure is used to synthesize polyurethane, although the obtained polyurethane has a relatively large modulus, its moisture permeability is insufficient. As shown by the results of Comparative Example 7, increasing the molecular weight of the polyether glycol can enhance the moisture permeability, but the increase in moisture permeability is not significant, and what is worse is that this leads to a substantial reduction in modulus, resulting in a loss of water resistance characteristics.

In contrast, the first soft segment (the aromatic polyether-ester group) used in Example 4 has a chemical structure represented by the following formula (IX):

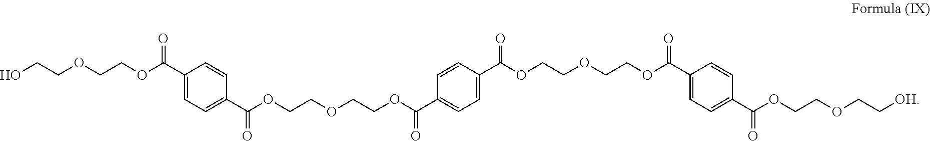 [SMILES: O=C(OCCOCCO)c1ccc(C(=O)OCCOCCOC(=O)c2ccc(C(=O)OCCOCCOC(=O)c3ccc(C(=O)OCCOCCO)cc3)cc2)cc1]

Therefore, the polyurethane waterproof film of Examples 1-5 can have both sufficient moisture permeability and modulus, and the above structure has a relatively high proportion of recycled materials, thus is can be environmental friendly and less carbon footprint.

Moreover, from the results of Comparative Example 5 and Example 7, when the molecular weight of the second soft segment (the aliphatic polyether segment) is relatively low, the polyurethane produced also has a relatively low moisture permeability.

The present disclosure is disclosed as above through the foregoing embodiments, which nevertheless are not intended to limit the present disclosure. Those with ordinary knowledge in the technical field to which the present disclosure belongs may make slight changes and modifications without departing from the spirit and scope of the present disclosure. Therefore, the protection scope of the present disclosure shall be subject to the definition of the appended claims. In addition, each claim constitutes an independent embodiment, and various combinations of the claims and embodiments are within the scope of the present disclosure.

What is claimed is:

1. A moisture permeable waterproof film, comprising a polyurethane, wherein the polyurethane includes a hard segment, a first soft segment and a second soft segment, the first soft segment includes an aromatic polyether-ester group, a modulus of the moisture permeable waterproof film is more than about 50 kgf/cm², a moisture permeability of the moisture permeable waterproof film is more than about 30000 g/m²*24 hr, and when an amount of the first soft segment is about 1 mole, an amount of the hard segment is equal to or more than about 4.5 moles,
wherein the first soft segment comprises a structure of formula (I) below:
—X1-Y1- Formula (I);
wherein X1 includes at least one aromatic isocyanate group, and Y1 includes the aromatic polyether-ester group, wherein Y1 includes a structure of formula (IA) or formula (IB) below:
—[(CO)—R—(CO)—O—R′—O]ₙ— Formula (IA);
—[(CO)—R—(CO)—O—R′—O—(CO)—O—R′—O]ₙ— Formula (IB);
wherein R is an aromatic group, R′ is a polyether group, the R groups in the first soft segments can be the same or different from one another, the R′ groups in the formula (IB) can be the same or different from one another, the CO groups connected to R are in ortho, meta or para position to each other, and n is an integer equal to or greater than 1;
wherein the second soft segment comprises a structure of formula (II) below:
—X2-Y2- Formula (II);
wherein X2 includes at least one aromatic isocyanate group, Y2 includes an aliphatic polyether group, a number average molecular weight of the aliphatic polyether group is equal to or greater than about 3000 g/mol, and Y2 includes a structure of formula (IIA) below:
—[O—R¹]ₘ₁—O— Formula (IIA);
wherein R¹ is a C2-C4 aliphatic hydrocarbon, m1 is an integer equal to or greater than 1, and when m1 is an integer equal to or greater than 2, R¹ may be the same or different each time it appears.

2. The moisture permeable waterproof film of claim 1, wherein when the amount of the first soft segment is about 1 mole, the amount of the hard segment is equal to or less than about 10 moles.

3. The moisture permeable waterproof film of claim 1, wherein the number average molecular weight of the aromatic polyether-ester group is equal to or greater than about 450 g/mol.

4. The moisture permeable waterproof film of claim 1, wherein the aromatic polyether-ester group is derived from a depolymerization product of a polyester and a polyether polyol, a polymer obtained by reacting the depolymerization product of the polyester and the polyether polyol with a carbonate, or a combination thereof.

5. The moisture permeable waterproof film of claim 1, wherein the hard segment includes a structure of formula (III) below:
—X3-Y3- Formula (III);
wherein X3 includes at least one aromatic isocyanate group, and Y3 includes a structure of formula (IIIA) below:
—O—R^{a}—O— Formula (IIIA);
wherein R^{a} is a C2-C4 aliphatic hydrocarbon.

6. The moisture permeable waterproof film of claim 1, wherein the modulus is equal to or less than about 80 kgf/cm².

7. The moisture permeable waterproof film of claim 1, wherein the number average molecular weight of the aliphatic polyether group ranges from 3000 g/mol to 9000 g/mol.

8. The moisture permeable waterproof film of claim 1, wherein a molar ratio of the first soft segment to a sum of the hard segment, the first soft segment, and the second soft segment is expressed as M1, M1=(S1/(H1+S1+S2))*100, wherein S1 is a mole number of the first soft segment, S2 is a mole number of the second soft segment, H1 is a mole number of the hard segment, and where M1 is equal to or less than about 20.

9. The moisture permeable waterproof film of claim 1, wherein when the amount of the first soft segment is about 1 mole, an amount of the second soft segment is about 0.1 to 1 mole.
